(19) United States
(12) Patent Application Publication
(10) Pub. No.: US 2015/0109460 A1
(43) Pub. Date: Apr. 23, 2015

(54) IMAGE DISPLAY SYSTEM, METHOD FOR CONTROLLING IMAGE DISPLAY SYSTEM, IMAGE DISPLAY DEVICE AND METHOD FOR CONTROLLING IMAGE DISPLAY DEVICE

(71) Applicant: CANON KABUSHIKI KAISHA, Tokyo (JP)

(72) Inventor: Osamu Yonishi, Chigasaki-shi (JP)

(21) Appl. No.: 14/507,120

(22) Filed: Oct. 6, 2014

(30) Foreign Application Priority Data
Oct. 22, 2013 (JP) 2013-219562
Apr. 9, 2014 (JP) 2014-080210

(51) Int. Cl. H04N 17/02

(52) U.S. Cl. CPC H04N 17/02
USPC 348/182

(57) ABSTRACT

An image display system comprises an image output device configured to output an image signal that matches a plurality of types of image display devices; and a simulation display device that is an image display device having a function of emulating any of characteristics of the plurality of types of image display devices, wherein the simulation display device includes a setting notification unit notifying the image output device of characteristics information that is an image transform parameter used for emulation, and the image output device includes a determination unit determining, on the basis of the obtained characteristics information, whether or not an image signal that is an output target matches a setting of the simulation display device.

### BACKGROUND OF THE INVENTION

1. Field of the Invention

The present invention relates to an image display system.

2. Description of the Related Art

In recent years, as high-definition and high-performance video image display devices, such as a cinema projector, have been in widespread use, there have been increased needs for production of a video image having a wide color gamut and a wide dynamic range.

Conventionally, video formats, such as ITU-R BT.709 (which will be hereinafter referred to as BT.709) and digital cinema initiatives (which will be herein after referred to as DCI), have been used, but in recent years, video formats which have a wider color gamut and a higher dynamic range have been proposed. For example, with SMPTE ST 2065-1:2012 (Academy Color Encoding Specification, which will be hereinafter referred to as ACES), a color space having a wider range than those of colors which are perceivable by human can be defined.

In order to display data in the ACES format by a display device corresponding to only conventional standards, such as BT.709, DCI, and the like, transform processing for a color space is needed. Therefore, in the ACES standard, transform processing, such as reference rendering transform (RRT) and output device transform (ODT), are defined.

As described above, color transform plays an important role in video image production.

Many display devices, such as a display used in video image production and the like, have a function (an emulation function) of checking a video image in accordance with a device with which a final product is viewed. Emulation is a technique in which visual performance when a video image is displayed by a certain display device is simulated by another display device having different characteristics. Using emulation, for example, the visual performance when an edited video image is projected by a projector can be checked by a liquid crystal display.

As a conventional technique relating to emulation, a display device is disclosed in Japanese Patent Application Laid-open No. 2008-085980. In the display device, a method in which, in order to transform each of input and output characteristics of a display device, which is an emulation target, input and output characteristics of a display device used in emulation, and a color gamut, a three-dimensional look up table (3D-LUT) is generated is used.

### SUMMARY OF THE INVENTION

Emulation has to be performed after setting made in a device (which will be hereinafter referred to as a display device) for displaying an image and setting made in a device (which will be hereinafter referred to as an output device) for outputting an image are made to match each other.

This point will be described. When emulation is performed, a user sets, for the display device, a gamma value, a color temperature, and the like, with which a desired display state can be obtained. On the other hand, the output device outputs an image that matches the display device that is to be a target. In this case, if an image that is to be output does not match the setting made at the display device side, a correct emulation result cannot be obtained.

In recent years, as the display device, there have been an increasing number of display devices which have a plurality of emulation modes in order to correspond to a plurality of image standards. Also, in order to correspond to various display devices, there have been an increasing number of output devices which are configured to enable the selection of a plurality of image standards. That is, the number of combinations of settings has increased, and the probability that such a setting mismatch occurs has increased. Furthermore, a high image quality format, such as a log format and the like, has been examined, and if a new image standard is developed in future, the number of combinations of settings will be further increased.

Thus, in the situation in which, in both of the output device and the display device, a plurality of parameters for an image can be selected, emulation might be executed in a state in which the setting at the output device side and the setting at the display device side do not match each other.

In view of the foregoing, the present invention has been devised, and it is therefore an object of the present invention to prevent, in emulation of an image, a setting mismatch between an image output apparatus and an image display apparatus.

The present invention in its one aspect provides an image display system comprises an image output device configured to output an image signal that matches a plurality of types of image display devices; and a simulation display device that is an image display device having a function of emulating any of characteristics of the plurality of types of image display devices, wherein the simulation display device includes a setting notification unit notifying the image output device of characteristics information that is an image transform parameter used for emulation, and the image output device includes a determination unit determining, on the basis of the obtained characteristics information, whether or not an image signal that is an output target matches a setting of the simulation display device.

The present invention in its another aspect provides a method for controlling an image display system including an image output device configured to output an image signal that matches a plurality of types of image display devices, and a simulation display device that is an image display device having a function of emulating any of characteristics of the plurality of types of image display devices, the method comprises giving, by the simulation display device, a notice of characteristics information that is an image transform parameter, set in the simulation display device and used for emulation, to the image output device; and determining, by the image output device, whether or not an image signal that is an output target matches a setting of the simulation display device on the basis of the obtained characteristics information.

The present invention in its another aspect provides an image display system which obtains an image signal from an image output device and emulates any of characteristics of the plurality of types of image display devices, the image display device comprises a setting notification unit notifying the image output device of characteristics information that is an image transform parameter used for emulation; a determination result reception unit receiving, from the image output device, information indicating whether or not the image signal and the image transform parameter match each other; and a notification unit giving to a user, when the image signal obtained from the image output device does not match the image transform parameter, a notice to that effect.

The present invention in its another aspect provides an image display device which obtains an image signal from an image output device and emulates any of characteristics of the plurality of types of image display devices, the image display device comprises a determination unit receiving a parameter representing a characteristic of the image signal from the image output device and determining whether or not the parameter and an image transform parameter used for emulation by the device itself match each other; and a notification unit giving to a user, when determination is made that the image signal obtained from the image output device does not match the image transform parameter, a notice to that effect.

The present invention in its another aspect provides a method for controlling an image display device which obtains an image signal from an image output device and emulates any of characteristics of the plurality of types of image display devices, the method comprises notifying the image output device of characteristics information that is an image transform parameter used for emulation; receiving, from the image output device, information indicating whether or not the image signal and the image transform parameter match each other; and giving to a user, when the image signal obtained from the image output device does not match the image transform parameter, a notice to that effect.

The present invention in its another aspect provides a method for controlling an image display device which obtains an image signal from an image output device and emulates any of characteristics of the plurality of types of image display devices, the method comprises receiving a parameter representing a characteristic of the image signal from the image output device and determining whether or not the parameter and an image transform parameter used for emulation by the device itself match each other; and giving to a user, when determination is made that the image signal obtained from the image output device does not match the image transform parameter, a notice to that effect.

The present invention in its another aspect provides an image display device which receives an image signal of the ACES standard and has a function of emulating characteristics of the plurality of types of image display devices, the image display device comprises a setting obtaining unit obtaining characteristics information that is an image transform parameter used for emulation; and an image transform unit performing, in use of the characteristics information, reference rendering transform (RRT) processing and output device transform (ODT) processing.

According to the present invention, a setting mismatch between an image output apparatus and an image display apparatus in emulation of an image can be prevented.

Further features of the present invention will become apparent from the following description of exemplary embodiments with reference to the attached drawings.

### BRIEF DESCRIPTION OF THE DRAWINGS

FIGS. 1A and 1B are device configuration views of a video image output system according to a first embodiment;

FIG. 2 is a functional block diagram of a display device according to the first embodiment;

FIG. 3 is a table illustrating the relationship between emulation mode and sub-setting;

FIG. 4 is a diagram illustrating communication between a display device and a video image output device using DisplayPort;

FIG. 5 is a diagram illustrating a communication sequence performed by a display device and a video output device;

FIG. 6 is a format diagram of data, which illustrates the setting contents of a display device;

FIG. 7 is a flow chart of processing performed by a display device according to the first embodiment;

FIG. 8 is a device configuration view of a video image output system according to a second embodiment;

FIG. 9 is a functional block diagram of a display device according to the second embodiment;

FIG. 10 is a flow chart of processing performed by a display device according to the second embodiment;

FIG. 11 is a functional block diagram of a display device according to a third embodiment; and

FIG. 12 is a flow chart of processing performed by a display device according to the third embodiment.

### DESCRIPTION OF THE EMBODIMENTS

Embodiments of the present invention will be described below with reference to the accompanying drawings. Note that like components are denoted by the same reference character and the description thereof will be omitted.

### First Embodiment

<System Configuration>

A video image display system according to a first embodiment is a system for causing a display device having a function (an emulation function) of emulating display characteristics of an arbitrary video image display device to display a video image output from a video image output device, and is an image display system in the present invention.

The emulation function is a function used mainly for absorbing difference between display devices and, for example, in a display device in which an LCD is built, visual performances in different display devices, such as a PDP, a CRT, and the like, can be reproduced. Also, it is known that, in a digital cinema projector, visual performance differs depending on the projection method, such as DLP, LCD, and the like, and emulation is used in order to check visual performances in different methods. Furthermore, when visual performance of a film projector is reproduced by a digital cinema projector, emulation is used.

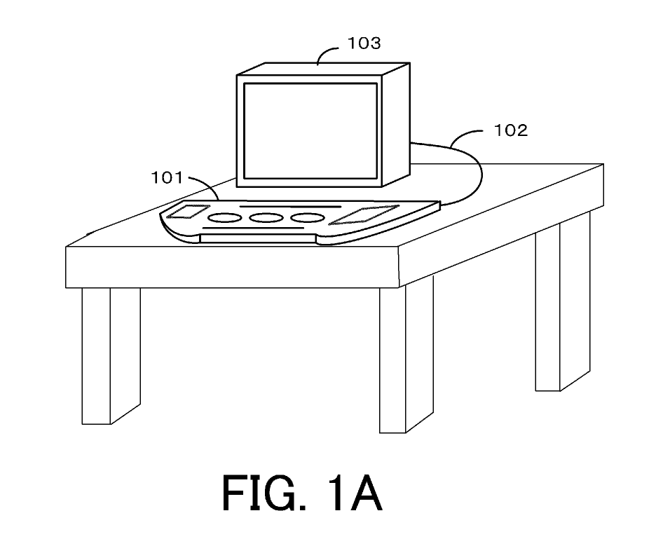

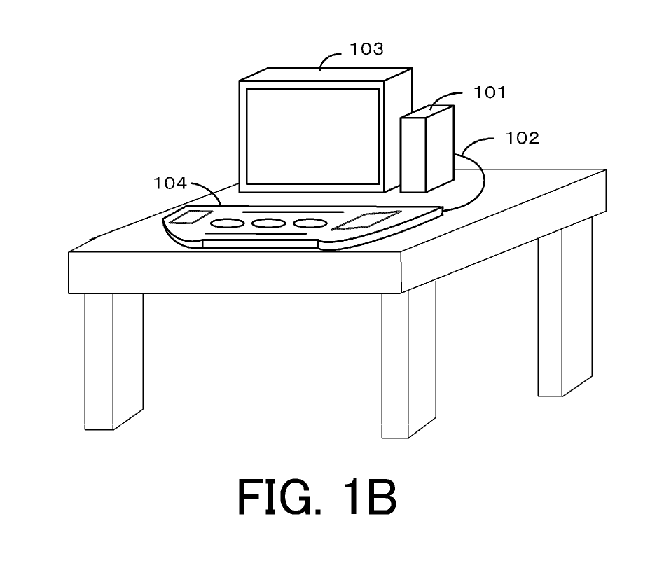

Emulation performed by a display device will be described with reference to FIG. 1A and FIG. 1B. A video image display system according to the first embodiment includes a video image output device 101, a cable 102, and a display device 103. FIG. 1A illustrates an example in which the video image output device 101 and a controller (a control operation unit) thereof are integrated as a single unit. FIG. 1B illustrates an example in which the video image output device 101 and a controller (a control operation unit) 104 for operating the video image output device 101 are separated.

The video image output device 101 is a device for outputting a digital video image, and typically, is a video image editing device, such as a digital video work station and the like. The video image output device 101 can output video image signals (image signals) of a plurality of types of standards which are generally used in video image production, e.g., DCI and BT. 709. In addition, the video image output device 101 can perform gamma correction, color temperature correction, and color gamut transform. Thus, the video image output device 101 can output a video image signal that matches an image display device (which will be hereinafter referred to as a target display) that finally puts a product on a screen.

The video image output device 101 is an image output device in the present invention.

The display device 103 is a device for displaying a video image output from the video image output device 101 and is a simulation display device in the present invention.

Many of display devices used for video image editing include a mode in which a target display is emulated. The display device used for editing is switched to a mode in which a target display is emulated and receives a video image signal output as a signal for target display from a video image output device, so that a user can check a video image with the same visual performance as that when a product is put on a screen.

When emulation is performed, the display device 103 selects a mode caused to match a target display. The mode is referred to as an emulation mode.

The display device 103 has a function of performing calibration with which a desired display state is achieved in order to accurately execute emulation. Specifically, a test signal (a color patch and the like) is displayed on a screen, and display characteristics data of the screen is obtained. Then, using the data, a deviation amount from an initial state is determined. Thus, an input video image is properly corrected and the accuracy of emulation can be maintained.

In general, it is known that emulation of a video image is performed using 3D-LUT in a display device, and the display device 103 executes emulation in a similar manner.

The cable 102 is a cable for connecting the video image output device 101 and the display device 103 and is typically a DisplayPort cable that can perform bidirectional communication. In this embodiment, a DisplayPort standard cable is used as a cable but, as long as data can be transmitted simultaneously with a video image, a cable of a standard other than the DisplayPort standard may be used.

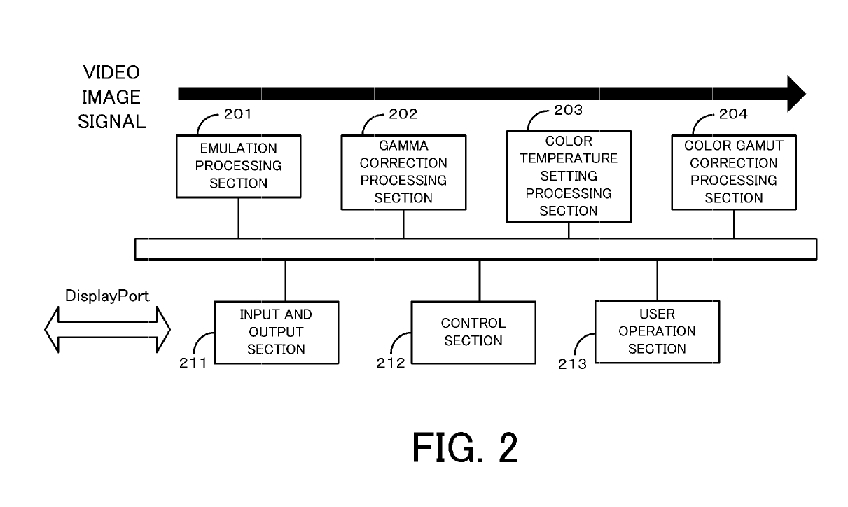

FIG. 2 is a functional block diagram of the display device 103.

The display device 103 includes, as a unit of transforming a video image signal, an emulation processing unit 201, a gamma correction processing unit 202, a color temperature setting processing unit 203, and a color gamut correction processing unit 204. The display device 103 also includes an input and output unit 211, a control unit 212, and a user operation unit 213.

First, the coordinate of a video image signal input via DisplayPort on a color space is transformed by the emulation processing unit 201. Next, gamma correction is performed by the gamma correction processing unit 202, and color temperature correction is performed by the color temperature setting processing unit 203. Finally, color gamut transform is performed by the color gamut correction processing unit 204. Note that the description using a function block is given for the purpose of illustrating examples, and each of the processes does not necessarily have to be performed separately and sequentially.

The input and output unit 211 is a unit performing input and output to and from the video image output device 101 via the cable 102 connected thereto, and is a setting notification unit and a determination result reception unit in the present invention. The control unit 212 is a unit of controlling video image transform processing. The user operation unit 213 is a unit obtaining an input from a user and presenting information to the user. Presentation of information does not necessarily have to be performed using an independent display device but may be performed, for example, using an on-screen display (OSD).

<Emulation Mode and Sub-Setting>

Next, setting used for performing emulation will be described.

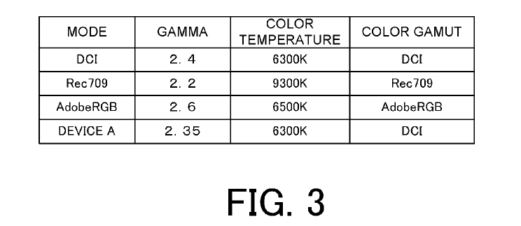

When emulation of a video image is performed, first, a mode (an emulation mode) is selected at the display device 103 side. FIG. 3 is a table indicating a value corresponding to each simulation mode. For example, when DCI is selected, the gamma value is 2.4, the color temperature is 6300 K, and the color gamut is DCI. Then, at the video image output device 101 side, a video image signal that targets DCI is output, thereby enabling check of a desired video image on the display device.

In this case, when a video image signal of the DCI format is output from the video image output device 101, the respective settings of the display device 103 and the video image output device 101 match each other, and thus, a desired emulation result can be achieved. However, when a video image signal of the BT.709 format is output from the video image output device 101, the respective settings of the display device 103 and the video image output device 101 do not match each other, and thus, a desired emulation result cannot be achieved.

Emulation of a video image is performed using 3D-LUT built in the display device 103. In a memory (not illustrated) of the display device 103, 3D-LUT for use in correction corresponding to each emulation mode is stored in advance, and 3D-LUT corresponding to the selected emulation mode is used.

In the display device 103, a table corresponding to FIG. 3 is stored and, when an emulation mode is selected, a corresponding target gamma value, a target color temperature, and a color gamut are extracted. These image transform parameters are called sub-setting. For example, when a device A is selected, 3D-LUT data corresponding to DCI, a gamma value of 2.35, and a color temperature of 6300 K are extracted.

As the sub-setting, a unique value is not necessarily used. For example, when a video image signal of the ITU-R BT.709 or DCI standard is dealt with, a color temperature set in the display device is 6500 K, 9300 K, or the like, in many cases, but there are cases where, depending on the emulation environment, a color temperature between the 6500 K and 9300 K is used. Similarly, the gamma setting is the 2.2 gamma characteristic, the 2.4 gamma characteristic, or the like, in many cases, but there are cases where, depending on the environment, a characteristic other than the foregoing is used.

Note that the sub-setting (the gamma value, the color temperature, and the color gamut) may be extracted together from data stored in advance, and may be separately input or selected by the user.

Next, using the sub-setting, processing (calibration) of correcting color deviation between a display device that is an emulation target and the display device 103 is executed. The processing is also called initialization correction processing. Initialization correction processing concurrently uses a tool that operates on a computer connected to the outside but, when initialization correction processing is executable by a display device alone, initialization correction processing may be executed by a single device alone.

When initialization correction processing is performed, a text signal (a color patch and the like) used for measuring a deviation amount from an initial state is displayed on a screen of the display device 103 and color characteristics data is obtained. Then, on the basis of the measurement result, a deviation amount from a standard state is calculated and 3D-LUT data used for emulation is corrected. Thus, correction for maintaining display accuracy can be performed.

However, in such initialization correction processing, an external tool and a display device are cooperated to each other and display of a test signal and obtaining of color characteristics data are repeated, and therefore, the initialization correction processing cannot be performed in a short time. There are cases where, depending on a device that is to be a target, it takes a few minutes to a few hours to perform initialization correction processing.

In this case, if there is a mismatch between the sub-setting selected or input by a user and a value set in the video image output device 101, a correct color cannot be displayed. Therefore, the user has to check whether or not the settings match to each other before emulation is started. If the user notices a mismatch between the settings after emulation is started, initialization correction processing has to be performed again.

The video image output system according to this embodiment is configured such that the display device notifies the video image output device of the current setting and thus can discover this mismatch beforehand.

<Setting Notification Method>

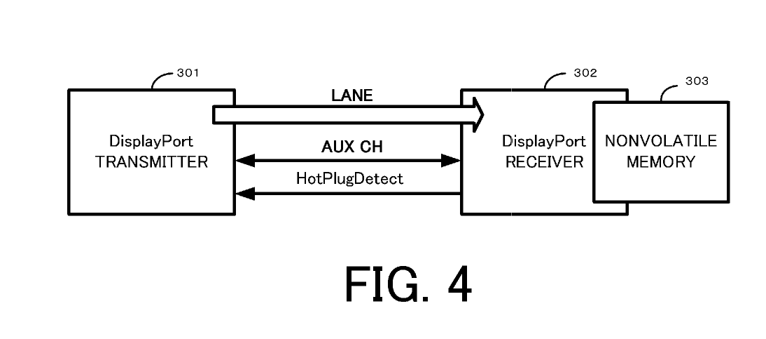

Next, a method in which the display device 103 notifies the video image output device 101 of the current setting will be described. FIG. 4 is a diagram illustrating connection between a DisplayPort transmitter 301 of the video image output device 101 and a DisplayPort receiver 302 of the display device 103. DisplayPort is a video image interface standard corresponding to bidirectional communication and enables data communication between a transmitter and a receiver. The DisplayPort receiver 302 and a nonvolatile memory 306 are built in the input and output unit 211.

DisplayPort includes mainly three transmission paths. LANE is a transmission path of a video image signal. AUX_CH is a transmission path for data transmission and can transmit extended display identification data (EDID). EDID is data used for transmitting corresponding video format between apparatuses, and the type of a video image signal that is transmittable can be identified by transmitting the data. In this embodiment, a setting mismatch between the apparatuses is detected using the EDID data. HotPlugDetect is a signal line used for detecting that the apparatuses are connected to each other.

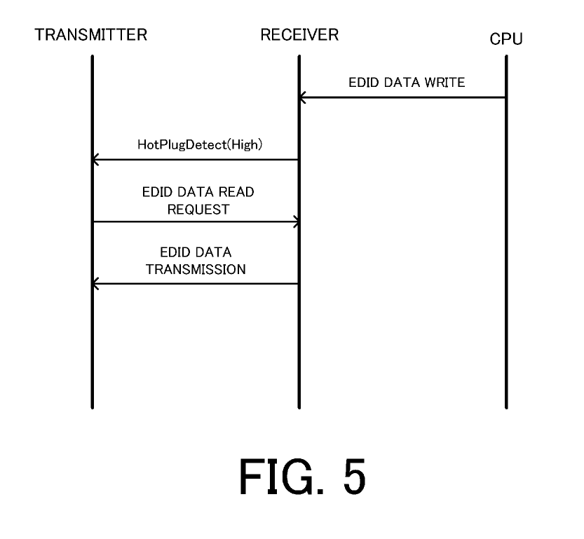

FIG. 5 is a diagram illustrating a communication sequence performed when the video image output device 101 detects a video format that can be displayed by the display device 103. First, the receiver sets the signal level of HotPlugDetect to be High. When the transmitter 301 detects that HotPlugDetect has been set to High, the transmitter 301 transmits a request for reading the EDID data, to the receiver 302. When the receiver 302 receives the request, the receiver 302 reads the EDID data from the nonvolatile memory 306 and transmits the read EDID data to the transmitter 301. Thus, the video image output device 101 can recognize the type of a video image signal that is transmittable.

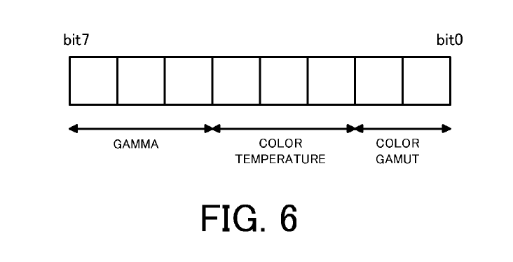

In this case, using the Reserve area of the EDID data that is transmitted, setting information is transmitted. FIG. 6 is a diagram illustrating an example format of the Reserve area. The Reserve area used in this embodiment is 8 bits, and therefore, in this example, high-order three bits are allocated as a gamma value, middle-order three bits are allocated as a color temperature, and low-order two bits are allocated as a color gamut. The values allocated in this case are not the gamma value and the color temperature themselves, but identifiers representing corresponding values. For example, 0×01 represents γ=2.2, and 0×02 represents γ=2.4. When all bits are 1, it is indicated that an allocated value is not a previously determined value but a value changed by the user. For example, when the high-order three bits are all 1, it is indicated that the gamma setting is changed to a custom value.

Information transmitted using the Reserve area is characteristics information in the present invention.

On the other hand, the video image output device 101 that has obtained the EDID data extracts the Reserve area and determines whether or not the corresponding gamma value, color temperature, and color gamut match the current video image output setting. If the corresponding gamma value, color temperature, and color gamut do not match the current video image output setting, the video image output device 101 notifies the display device 103, via DisplayPort, of the occurrence of a setting mismatch, and the display device 103 performs error display. Thus, the video image display system can notifies the user that the setting of the display device 103 and the setting of the video image output device 101 do not match each other. Note that, when such a notice cannot be transmitted via DisplayPort, notification maybe performed using a different unit, such as, for example, a network cable and the like.

<Processing Flow Chart>

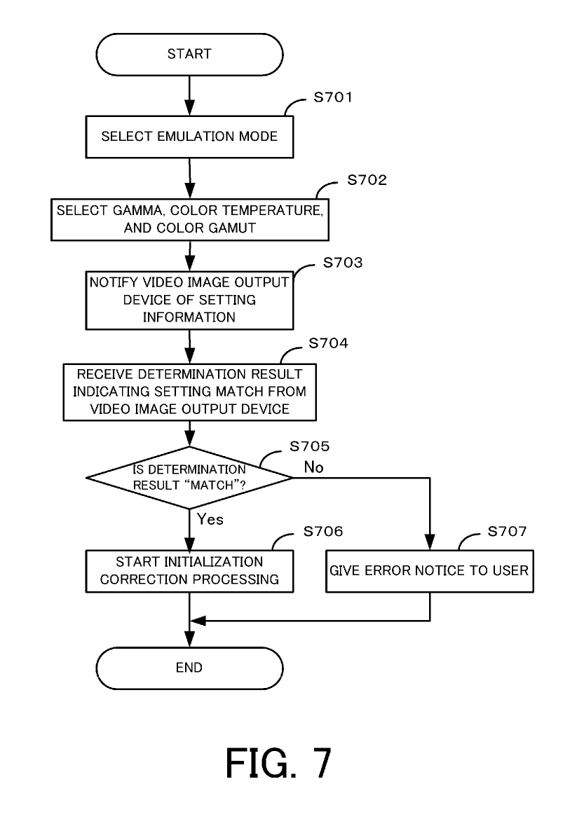

Next, a flow chart of processing performed by the display device 103 in order to execute the above-described processing will be described with reference to FIG. 7.

First, a user inputs a desired emulation mode via the user operation unit 213 (Step S701). The emulation mode may be selected from a plurality of modes via a menu (an on-screen display) displayed on a screen, and may be input or selected using an input device provided separately from the screen.

Next, the user inputs, as sub-setting, desired color temperature, gamma characteristics, and color gamut via the user operation unit 213 (Step S702). The sub-setting may be input to a sub menu screen and may be input using an input device provided separately from a screen. When there are previously stored setting values, the setting values may be selected on the basis of input.

Next, a notice of the setting contents that have been input is given to the video image output device 101 (Step S703). Specifically, the control unit 212 obtains the sub-setting from the user operation unit 213, writes data to the EDID information via the input and output unit 211, and thereafter, the above-described processing is executed. Note that, in this embodiment, the display device 103 performs notification to the video image output device 101 using HotPlugDetect, but a video image output device may be configured to perform polling on a display device to obtain data.

Next, the video image output device 101 determines, on the basis of the obtained EDID information, whether or not the video image that is an output target matches the current setting of the display device. A notice of the determination result is given to the display device 103 via the input and output unit 211 (Step S704).

On the other hand, the control unit 212 obtains the determination result (Steps S705) and, if the result is “match”, the control unit 212 executes initialization correction processing (calibration) (Step S706). If the result is “mismatch”, the control unit 212 notifies the user via the user operation unit 213 that the setting of the display device and the setting of the video image output device do not match each other (Step S707). This notification is performed using, for example, an on-screen display and the like.

Note that the case where the result is “mismatch” is a case where the setting of at least one of the gamma value, color temperature, and color gamut at the video image output device side differs relative to the emulation mode selected at the display device side. For example, if, at the display device side, the gamma value is set to 2.4, the color temperature is set to 6300 K, and the color gamut is set to DCI, and at the video image output device, the gamma value is set to 2.2, the color temperature is set to 9300 K, and the color gamut is set to BT.709, it is determined that the result is “mismatch”. In this case, a notice that the setting of the display device and the setting of the video image device do not match each other is given.

However, even when the gamma value, color temperature, and color gamut do not accurately match, as long as a difference is in an allowable range, it may be determined that the result is “match”. For example, if, at the video image output device side, as output setting for the gamma value, the color temperature, and the color gamut, 2.35, 9300 K, and BT.709 are set, respectively, it may be determined that the result is “match”.

As described above, in a video image display system according to the first embodiment, a display device notifies a video image output device of a setting state thereof, and thus, a setting mismatch between the display device and the output device can be detected, and a notice that the mismatch has been detected can be given to the user. When a setting mismatch occurs, a correct emulation result cannot be obtained and it is difficult to ensure the quality of a video image, but in the video image display system according to this embodiment, such difficulty can be reduced. In addition, the execution of initialization correction processing in a state where the settings do not match each other can be prevented and a loss in time can be reduced.

### Modified Example of First Embodiment

In the first embodiment, when a setting mismatch occurs, a notice that a setting mismatch has occurred is given to the user in order to urge the user to correct the setting but, the video image display system may be configured such that, when the mismatch can be removed by correcting a video image in the video image output device 101, transform of the video image is performed at the video image output device side.

For example, when, as a result of executing Step S703, the settings do not match each other, the video image output device 101 transmits, to the display device 103, a message indicating that the setting of the output video image is to be changed and, after the change of setting is completed, the process proceeds to processing of Step S706. When the setting cannot be changed to a matching format, the process proceeds to processing of Step S707.

When a mismatch can be removed by correcting a video image at the video image output device 101 side, the processing according to this modified example is performed, and thus emulation can be continued without suspension of processing.

### Second Embodiment

In the above-described embodiment, the setting information of the EDID information transmitted and received via the DisplayPort cable is transmitted using the Reserve area. However, the size of the area is short, that is, 8 bits, and therefore, only previously determined values can be represented. That is, even when a video image can be corrected at the video image output device side, if the user has set an arbitrary value, a specific value cannot be transmitted, and thus, correction cannot be performed.

In contrast, in a second embodiment, the display device 103 and the video image output device 101 are connected using, in addition to the DisplayPort cable, a network cable, and more detailed information is transmitted.

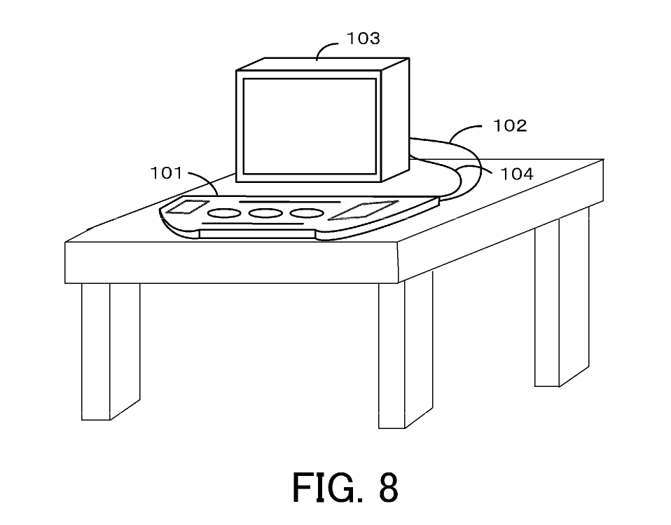

FIG. 8 is a view illustrating a system configuration of a video image display system according to the second embodiment.

In the second embodiment, the video image output device 101 and the display device 103 are connected via, in addition to the cable 102 for video image transmission, a network cable 104. In this embodiment, similar to the first embodiment, DisplayPort is used as the cable 102 for video image transmission.

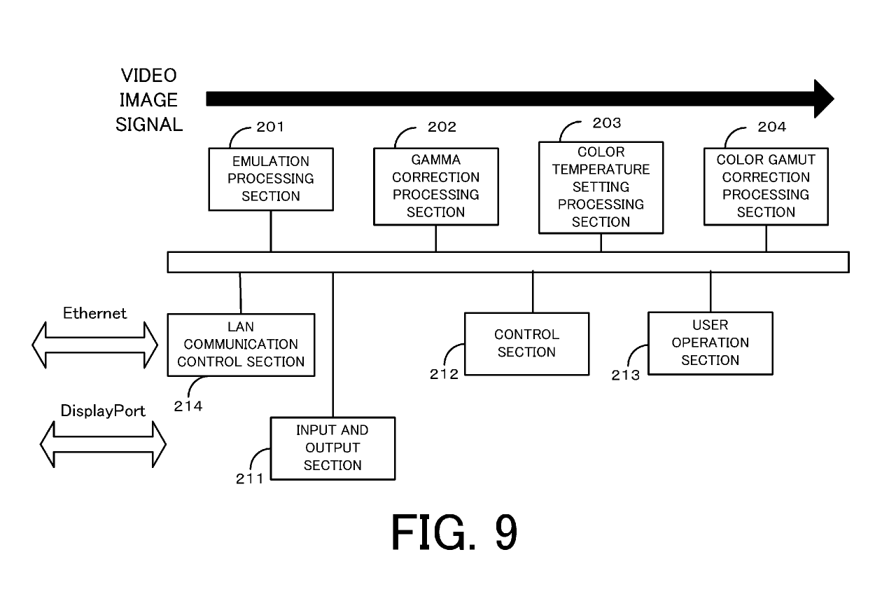

FIG. 9 is a diagram illustrating a functional block configuration of a display device 103 according to the second embodiment. The display device 103 according to the second embodiment includes a LAN communication control unit 214, and is different from that of the first embodiment in this point. The LAN communication control unit 214 is a unit of inputting and outputting information via a network interface and is a correction data transmission unit in the present invention. Other configurations are similar to corresponding configurations of the first embodiment.

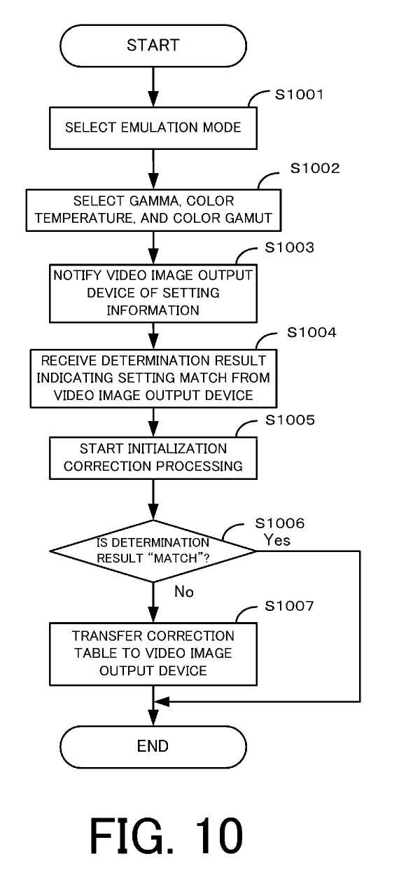

Processing performed by the video image output system according to the second embodiment will be described with reference to FIG. 10, which is a processing flow chart.

Processing of Steps S1001 to S1004 are similar to Steps S701 to S704 of the first embodiment, and therefore, the detailed description thereof will be omitted. In Step S1004, the display device 103 receives a determination result from the video image output device 101.

In Step S1005, regardless of the determination result received in Step S1004, the display device 103 starts initialization correction processing.

In Step S1006, the display device 103 determines the received result and, if the result is “match”, the display device 103 ends the processing. On the other hand, if the received result is “mismatch”, correction data is transmitted to the video image output device 101 via the network cable 104 (Step S1007).

The correction data is data used for causing the emulation setting at the display device side and the output setting at the video image output device side to match each other. Specifically, data used for performing gamma correction, color temperature correction, color gamut transform, and the like, at the video image output device 101 side, and is second characteristics information. Typically, when gamma correction is performed, the correction data is a one-dimensional look up table (1D-LUT) and, when color temperature is corrected, the correction data is a coordinate value of a white point. When color gamut transform is performed, the correction data is a three-dimensional look up table (3D-LUT). However, video image correction may be performed using data other than the above-described data.

Then, the video image output device 101 receives correction data, performs video image transform processing using the correction data, and outputs the transformed video image to the display device 103.

In the first embodiment, the size of an area that can be used for transmitting the setting is small, and therefore, when a preset value that has been previously set is changed to an arbitrary value by a user, the video image output device cannot correspond to such a change. In contrast, in the second embodiment, correction data is transmitted between devices, and thus, even when an arbitrary value is set at the display device side, video image correction can be performed at the video image output device side.

### Third Embodiment

There are cases where, when the display device corresponds to the ACES standard, reference rendering transform (RRT) processing and output device transform (ODT) processing which are defined in IIF of ACES are mounted in the display device. Each of RRT and ODT is video image transform processing applied in accordance with an output destination device and is mounted typically as transform processing using 3D-LUT.

In the second embodiment, the video image output device 101 performs video image transform using LUT, thereby removing a setting mismatch. In contrast, in a third embodiment, the display device 103 executes RRT and ODT, thereby removing a setting mismatch.

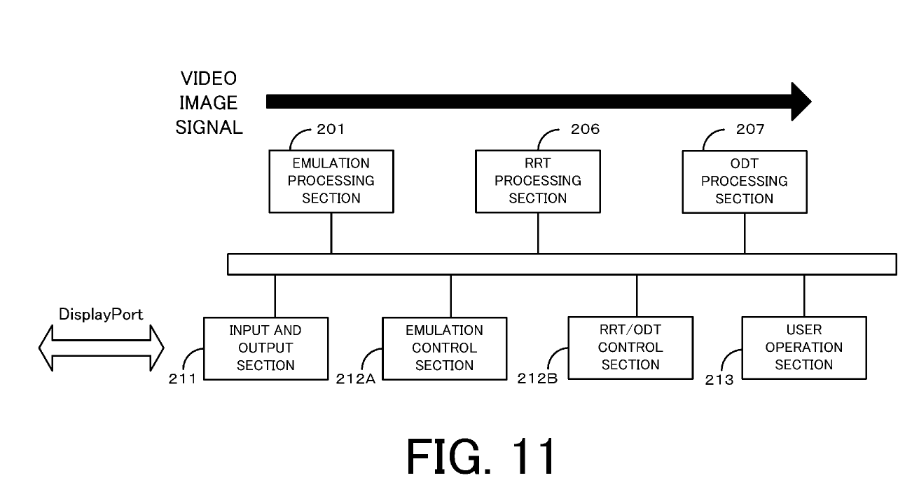

FIG. 11 is a diagram illustrating a functional block configuration of a display device 103 according to the third embodiment.

The display device 103 according to the third embodiment includes, instead of the gamma correction processing unit 202, the color temperature setting processing unit 203, and the color gamut correction processing unit 204, an RRT processing unit 206, and an ODT processing unit 207, and is different from that of the first embodiment in this point.

The display device 103 according to the third embodiment is different from that of the first embodiment also in that the control unit 212 is divided into an emulation control unit 212A and an RRT/ODT control unit 212B. The emulation control unit 212A is a unit controlling emulation processing, and the RRT/ODT control unit 212B is a unit controlling RRT and ODT.

After being subjected to emulation processing in the emulation processing unit 201, a video image signal that has been input is subjected to RRT in the RRT processing unit 206 and ODT in the ODT processing unit 207, and then, is output as a desired video image.

The RRT processing unit 206 and the ODT processing unit 207 are an image transform unit in the present invention. The user operation unit 213 is a setting obtaining unit in the present invention.

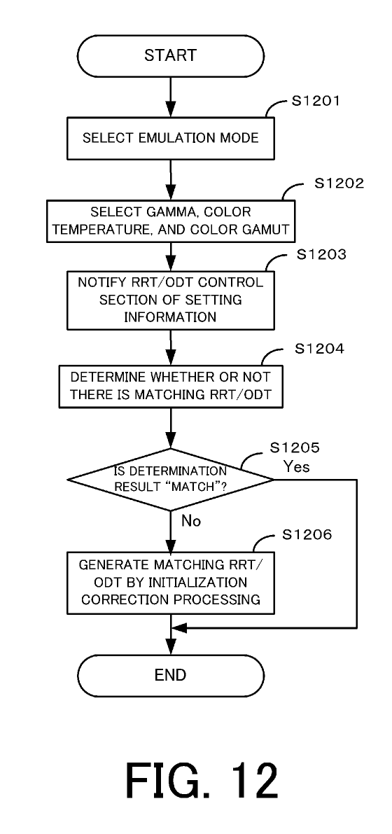

A flow chart of processing performed by the display device 103 according to the third embodiment will be described with reference to FIG. 12.

Steps S1201 and S1202 are similar to Steps S701 and S702 of the first embodiment, and therefore, the detailed description thereof will be omitted.

When an emulation mode and a sub-setting are selected, the user operation unit 213 notifies the RRT/ODT control unit 212B of the contents of the sub-setting (Step S1203).

Next, in Step S1204, the RRT/ODT control unit 212B determines whether or not the selected emulation mode and the RRT/ODT data that has been held match each other. As a result (Step S1205), if the result is “match”, the process is ended, and if the result is “mismatch”, initialization correction processing is started to generate matching RRT/ODT data (Step S1206).

In this case, RRT processing is reference rendering transform processing of transforming ACES data to output color encoding specification (OCES) data that matches an idealized display device. For example, the processing includes gradation transform processing, color correction processing, and the like, using 1D-LUT and 3D-LUT. ODT processing is output device transform processing of transforming OCES data that has been RRT transformed in accordance with the output device. For example, the processing includes gradation transform processing, color space transform processing, and the like, using 1D-LUT. RRT/ODT data is data in the 1D-LUT format or the 3D-LUT format used in RRT processing and ODT processing.

As described above, when RRT/ODT can be performed at the display device side, as in this embodiment, transform processing is performed in the display device, and thus, a setting mismatch from the video image output device can be removed.

Note that, in this embodiment, the RRT processing unit 206 and the ODT processing unit 207 are separately described, but the RRT processing unit 206 and the ODT processing unit 207 may be mounted together as a single processing block. In this case, only a single 3D-LUT is necessary for adjustment.

In this embodiment, a video image is transformed by RRT/ODT, but when a video image is not complied with the ACES standard, transform may be performed by a method other than the above-described method. In such a case, information necessary for transforming a video image may be obtained from the video image output device 101.

### MODIFIED EXAMPLE

Note that each embodiment has been described merely to illustrate an example of the present invention and the present invention may be modified and combined as appropriate without departing from the principles of the invention. For example, the present invention may be embodied as a video image display system including at least a part of the above-described processing. The present invention may be embodied as a method for controlling a video image display system. The present invention may be embodied as some other device including a video image output device and a display device. The present invention may be embodied as a single body video image display device. The present invention may be embodied by freely combining the above-described processing and units unless any technical contradiction occurs.

In the first and second embodiments, the display device 103 notifies the video image output device 101 of a setting and the video image output device 101 determines whether or not the setting and a video image that is an output target match each other, but the determination may be performed at the display device 103 side.

In this case, for example, in Step S703, the video image output device 101 may notify the display device 103 of parameters relating to a video image that is an output target and, in Step S704, the display device 103 may compare the current setting with the obtained parameters and determine whether or not the parameters match the current setting. A notice of the parameters relating to the video image that is an output target can be given via DisplayPort using the format illustrated in FIG. 6. Since a transmission path for data communication allows bidirectional communication, the above-described modification is possible. In this case, a notice of setting information does not have to be given from the display device 103 to the video image output device 101.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-219562, filed on Oct. 22, 2013, and Japanese Patent Application No. 2014-080210, filed on Apr. 9, 2014, which are hereby incorporated by reference herein in their entirety.

What is claimed is:

1. An image display system, comprising:
an image output device configured to output an image signal that matches a plurality of types of image display devices; and
a simulation display device that is an image display device having a function of emulating any of characteristics of the plurality of types of image display devices,
wherein the simulation display device includes a setting notification unit notifying the image output device of characteristics information that is an image transform parameter used for emulation, and
the image output device includes a determination unit determining, on the basis of the obtained characteristics information, whether or not an image signal that is an output target matches a setting of the simulation display device.

2. The image display system according to claim 1, wherein, when the image signal that is an output target does not match the setting of the simulation display device, the image output device transforms the image signal that is an output target, on the basis of the characteristics information obtained from the setting notification unit.

3. The image display system according to claim 1, wherein, when the image signal that is an output target does not match the setting of the simulation display device, the determination unit gives a notice to the simulation display device, and the simulation display device gives to a user, on the basis of the notice, a notice to the effect that the image signal that is output from the image output device does not match a current setting.

4. The image display system according to claim 1, wherein the simulation display device further includes a correction data transmission unit transmitting second characteristics information that is more detailed information than the characteristics information to the image output device, and
when the image signal that is an output target does not match the setting of the simulation display device, the image output device obtains the second characteristics information from the display device and transforms the image signal that is an output target, using the second characteristics information.

5. The image display system according to claim 1, wherein the characteristics information includes information indicating at least any of a target color temperature, a target gamma value, and a color gamut used by the simulation display device for emulation.

6. A method for controlling an image display system including an image output device configured to output an image signal that matches a plurality of types of image display devices, and a simulation display device that is an image display device having a function of emulating any of characteristics of the plurality of types of image display devices,
the method comprising:
giving, by the simulation display device, a notice of characteristics information that is an image transform parameter, set in the simulation display device and used for emulation, to the image output device; and
determining, by the image output device, whether or not an image signal that is an output target matches a setting of the simulation display device on the basis of the obtained characteristics information.

7. The method for controlling an image display system according to claim 6, further comprising:
transforming, by the image output device, the image signal that is an output target on the basis of the characteristics information obtained from the display device, when the image signal that is an output target does not match the setting of the simulation display device.

8. The method for controlling an image display system according to claim 6, wherein
in the determining, when the image signal that is an output target does not match the setting of the simulation display device, a notice is given to the simulation display device,
the method further including giving to a user, by the simulation display device, on the basis of the notification, a notice to the effect that the image signal that is output from the image output device does not match a current setting.

9. The method for controlling an image display system according to claim 6, further comprising:
transmitting, by the simulation display device, second characteristics information that is more detained information than the characteristics information to the image output device; and
obtaining, by the image output device, the second characteristics information from the display device, when the image signal that is an output target does not match the setting of the simulation display device, and transforming the image signal that is an output target, using the second characteristics information.

10. The method for controlling an image display system according to claim 6, wherein the characteristics information includes information indicating at least any of a target color temperature, a target gamma value, and a color gamut used by the simulation display device for emulation.

11. An image display system which obtains an image signal from an image output device and emulates any of characteristics of the plurality of types of image display devices,
the image display device comprising:
a setting notification unit notifying the image output device of characteristics information that is an image transform parameter used for emulation;
a determination result reception unit receiving, from the image output device, information indicating whether or not the image signal and the image transform parameter match each other; and
a notification unit giving to a user, when the image signal obtained from the image output device does not match the image transform parameter, a notice to that effect.

12. The image display device according to claim 11, further comprising:
a correction data transmission unit transmitting, to the image output device, second characteristics information that is information used by the image output device to transform the image signal.

13. The image display device according to claim 11, wherein the characteristics information includes information indicating at least any of a target color temperature, a target gamma value, and a color gamut used by the device itself for emulation.

14. An image display device which obtains an image signal from an image output device and emulates any of characteristics of the plurality of types of image display devices,
the image display device comprising:
a determination unit receiving a parameter representing a characteristic of the image signal from the image output device and determining whether or not the parameter and an image transform parameter used for emulation by the device itself match each other; and
a notification unit giving to a user, when determination is made that the image signal obtained from the image output device does not match the image transform parameter, a notice to that effect.

15. A method for controlling an image display device which obtains an image signal from an image output device and emulates any of characteristics of the plurality of types of image display devices,
the method comprising:
notifying the image output device of characteristics information that is an image transform parameter used for emulation;
receiving, from the image output device, information indicating whether or not the image signal and the image transform parameter match each other; and
giving to a user, when the image signal obtained from the image output device does not match the image transform parameter, a notice to that effect.

16. The method for controlling an image display device according to claim 15, further comprising:
transmitting, to the image output device, second characteristics information that is information used by the image output device to transform the image signal.

17. The method for controlling an image display according to claim 15, wherein the characteristics information includes information indicating at least any of a target color temperature, a target gamma value, and a color gamut used for emulation by the device itself.

18. A method for controlling an image display device which obtains an image signal from an image output device and emulates any of characteristics of the plurality of types of image display devices,
the method comprising:
receiving a parameter representing a characteristic of the image signal from the image output device and determining whether or not the parameter and an image transform parameter used for emulation by the device itself match each other; and
giving to a user, when determination is made that the image signal obtained from the image output device does not match the image transform parameter, a notice to that effect.

19. An image display device which receives an image signal of the ACES standard and has a function of emulating characteristics of the plurality of types of image display devices,
the image display device comprising:
a setting obtaining unit obtaining characteristics information that is an image transform parameter used for emulation; and
an image transform unit performing, in use of the characteristics information, reference rendering transform (RRT) processing and output device transform (ODT) processing.
